(19) United States
(12) Patent Application Publication
(10) Pub. No.: US 2026/0254498 A1
(43) Pub. Date: Aug. 27, 2026

(54) TWO-STAGE LINEAR COMBINATION CHANNEL STATE INFORMATION FEEDBACK

(71) Applicant: MEDIATEK INC., Hsinchu City (TW)

(72) Inventors: Tzu-Han CHOU, San Jose, CA (US); Chia-Hao YU, Hsinchu City (TW); Chin-Kuo JAO, Hsinchu City (TW); Chun-Chia TSAI, Hsinchu City (TW); Jiann-Ching GUEY, Hsinchu City (TW)

(21) Appl. No.: 18/995,410

(22) PCT Filed: Jul. 25, 2023
(86) PCT No.: PCT/CN2023/109093

§ 371 Date: Jan. 16, 2025

Related U.S. Application Data
(60) Provisional application No. 63/369,389, filed on Jul. 26, 2022.

(51) Int. Cl. H04B 7/06; H04L 27/26

(52) U.S. Cl. CPC H04B 7/0626; H04B 7/0639; H04L 27/265

(57) ABSTRACT

A UE obtains a phase rotation matrix that transforms an original channel state information matrix into a rotated channel state information matrix. The UE determines the original channel state information matrix based on measurements of reference signals transmitted by a base station. The UE applies the phase rotation matrix to the original channel state information matrix to generate the rotated channel state information matrix. The UE determines a first set of coefficients that is to be applied to a Discrete Fourier Transform (DFT) basis matrix to obtain the rotated channel state information matrix. The UE reports a second set of coefficients derived from the first set of coefficients to the base station.

### CROSS-REFERENCE TO RELATED APPLICATION(S)

This application claims the benefits of U.S. Provisional Application Ser. No. 63/369,389, entitled “TWO STAGES LINEAR COMBINATION CSI FEEDBACK” and filed on Jul. 26, 2022, which is expressly incorporated by reference herein in their entirety.

### BACKGROUND

### Field

The present disclosure relates generally to communication systems, and more particularly, to techniques of channel state information (CSI) compression at user equipment (UE).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE obtains a phase rotation matrix that transforms an original channel state information matrix into a rotated channel state information matrix. The UE determines the original channel state information matrix based on measurements of reference signals transmitted by a base station. The UE applies the phase rotation matrix to the original channel state information matrix to generate the rotated channel state information matrix. The UE determines a first set of coefficients that is to be applied to a Discrete Fourier Transform (DFT) basis matrix to obtain the rotated channel state information matrix. The UE reports a second set of coefficients derived from the first set of coefficients to the base station.

In an aspect of the disclosure, a method, a computer-readable medium, and an apparatus are provided. The apparatus may be a base station. The base station receives coefficients for recovering a channel state information matrix from a user equipment (UE). The base station obtains a Discrete Fourier Transform (DFT) basis matrix. The base station recovers a rotated channel state information matrix by applying the received coefficients to the DFT basis matrix. The base station applies a phase rotation matrix to the rotated channel state information matrix to obtain an approximate original channel state information matrix. The base station utilizes the approximate original channel state information matrix for wireless communication with the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications between a base station and UE.

FIG. 8 is a diagram illustration technique of CSI compression based on two-stage linear combination.

FIG. 9 is a diagram illustrating an example of phase rotated DFT basis.

FIG. 10 is a flow chart of a method (process) for channel state information matrix reporting.

FIG. 11 is a flow chart of a method (process) for channel state information matrix recovery.

FIG. 12 is a diagram illustrating an example of a hardware implementation for an apparatus employing a processing system.

FIG. 13 is a diagram illustrating an example of a hardware implementation for another apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

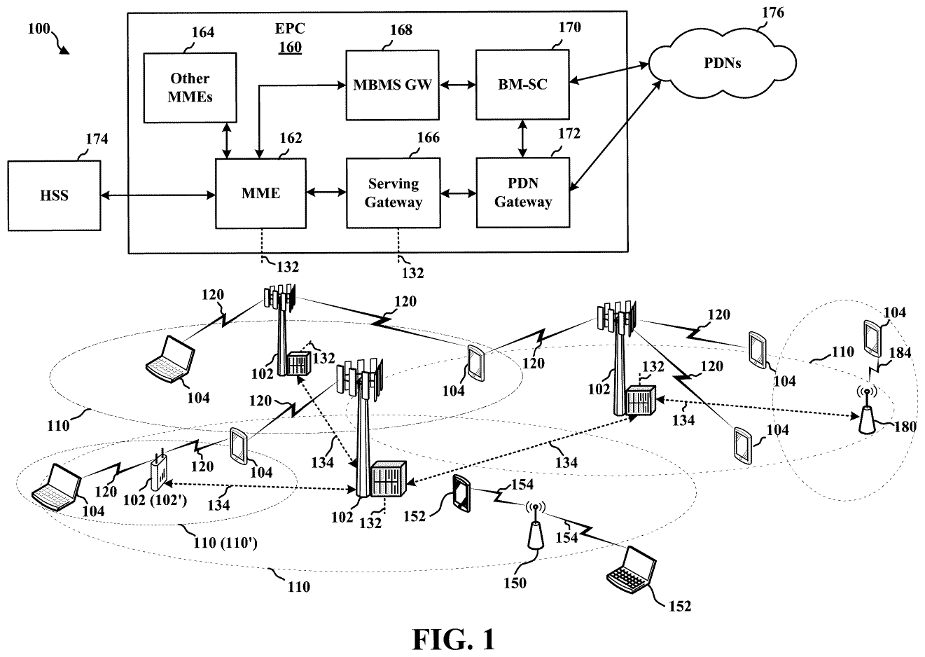

FIG. 1 is a diagram illustrating an example of a wireless communications system and an access network 100. The wireless communications system (also referred to as a wireless wide area network (WWAN)) includes base stations 102, UEs 104, and a core network 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the core network 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the core network 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 1 10. For example, the small cell 102′ may have a coverage area 110′ that overlaps the coverage area 1 10 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The core network 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the core network 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the core network 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

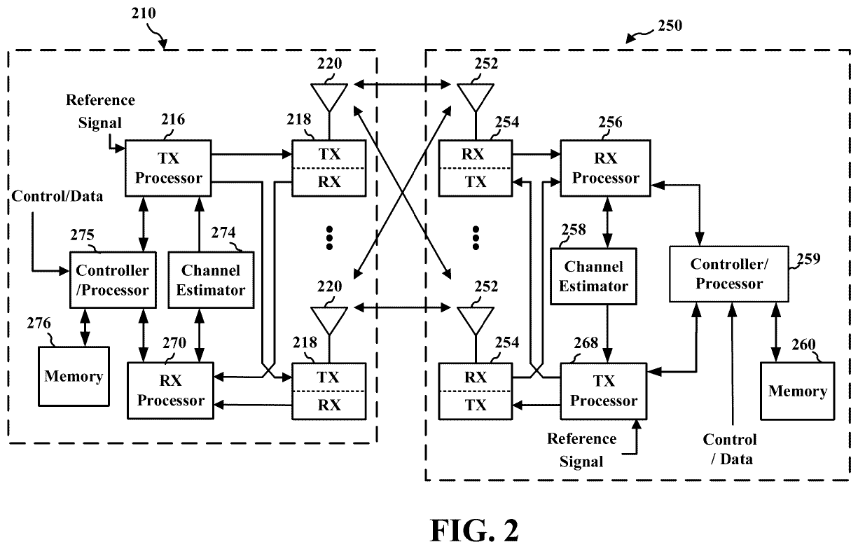

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

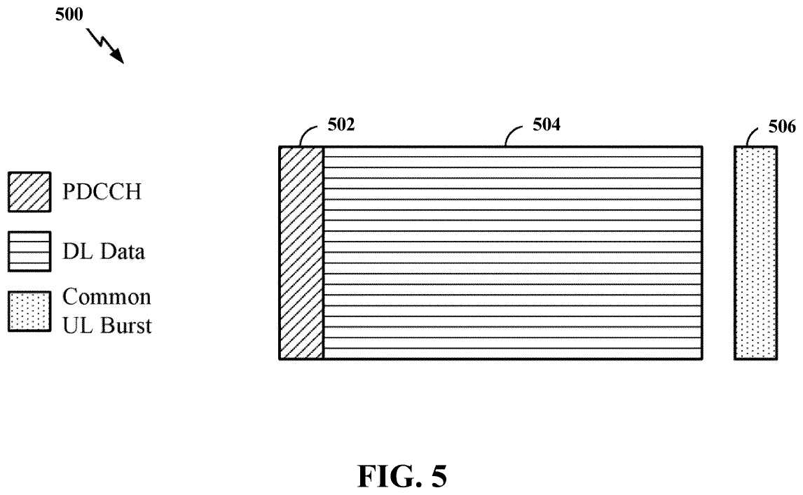

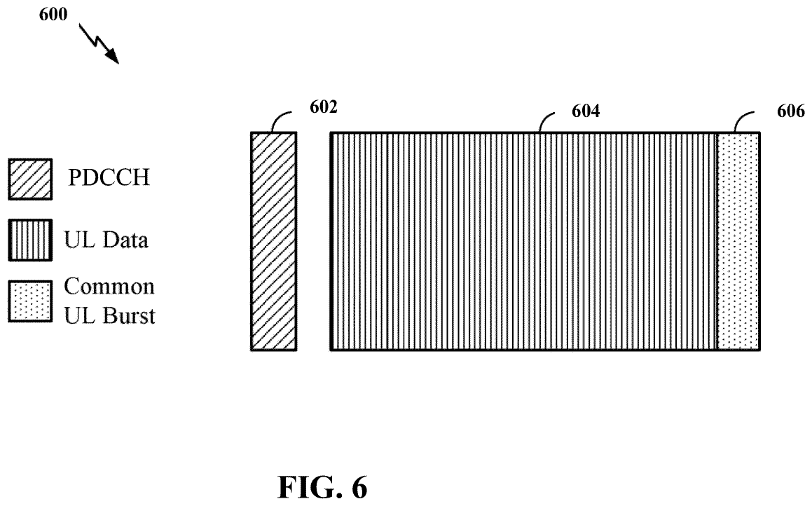

A single component carrier bandwidth of 100 MHZ may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

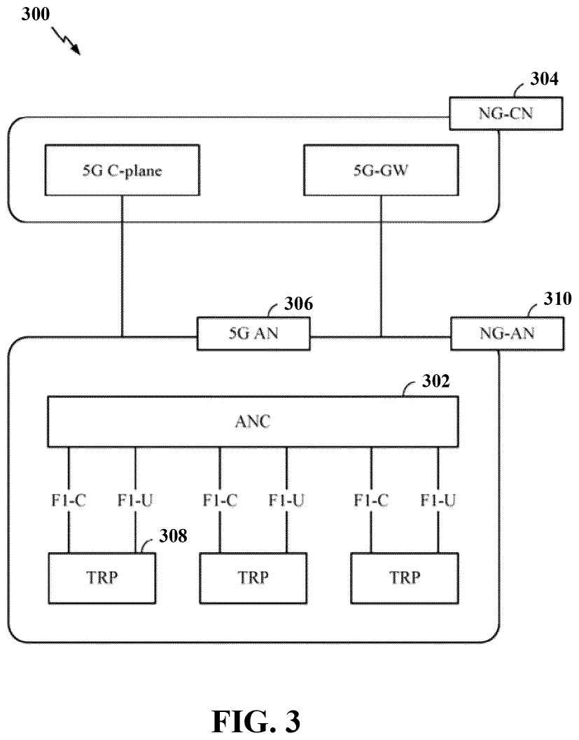

FIG. 3 illustrates an example logical architecture 300 of a distributed RAN, according to aspects of the present disclosure. A 5G access node 306 may include an access node controller (ANC) 302. The ANC may be a central unit (CU) of the distributed RAN 300. The backhaul interface to the next generation core network (NG-CN) 304 may terminate at the ANC. The backhaul interface to neighboring next generation access nodes (NG-ANs) may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

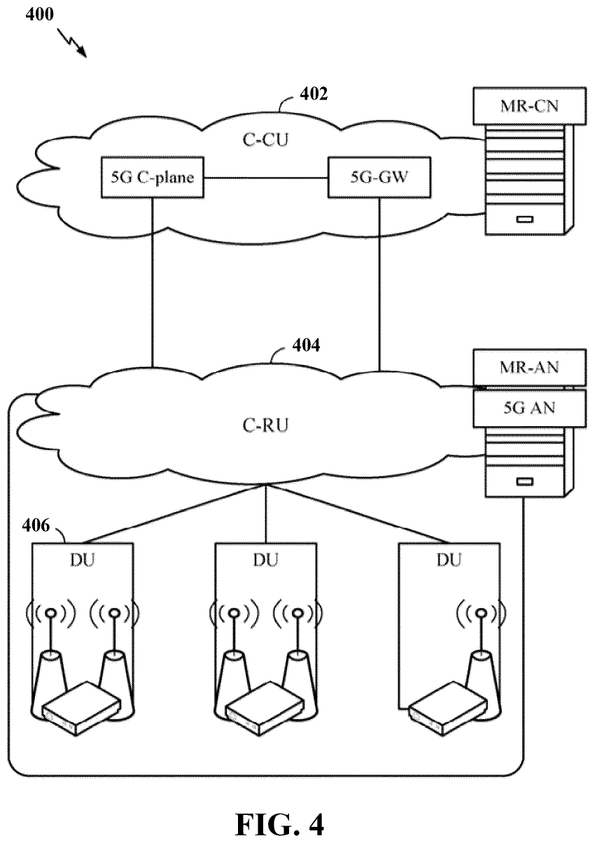

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 606 described above with reference to FIG. 6. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such side link communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

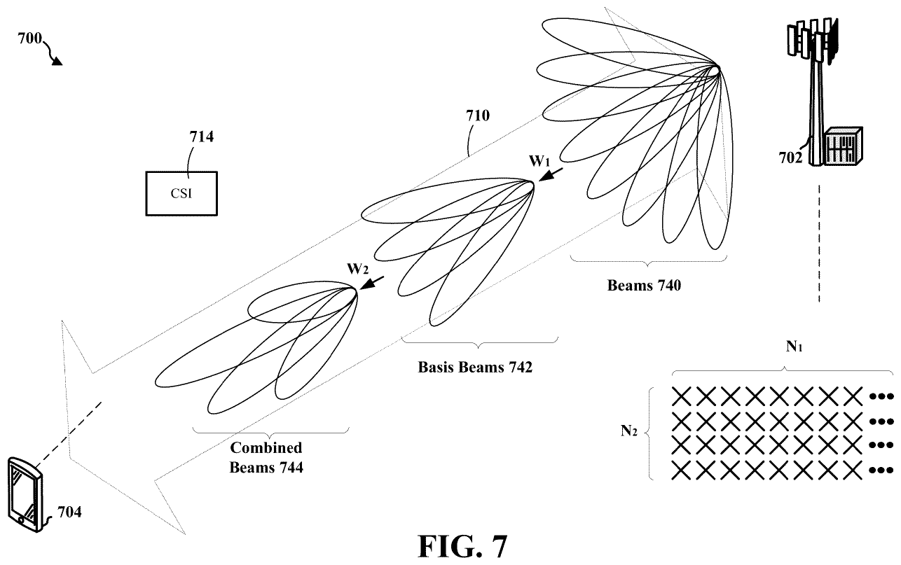

FIG. 7 is a diagram 700 illustrating communications between a base station 702 and a UE 704 on a channel 710. Further, the base station 702 may transmit spatial beams 740 on the channel 710. Channel properties of the channel 710 (i.e., a wireless communication link) is referred to as channel state information (CSI) 714. This information describes how a signal propagates from the transmitter at the base station 702 to the receiver at the UE 704 and represents the combined effect of scattering, multipath fading, signal power attenuation with distance, etc. The knowledge of the CSI 714 at the transmitter and/or the receiver makes it possible to adapt data transmission to current channel conditions, which is crucial for achieving reliable and robust communication with high data rates in multi-antenna systems. The CSI 714 is often required to be estimated at the receiver, and usually quantized and fed back to the transmitter.

The time and frequency resources that can be used by the UE 704 to report the CSI 714 are controlled by the base station 702. The CSI 714 may include CQI, PMI, CSI-RS resource indicator (CRI), SS block resource indicator, layer indication (LI), rank indicator (RI), and/or and L1-RSRP measurements. For CQI, PMI, CRI, LI, RI, L1-RSRP, the UE 704 may be configured via RRC signaling with more than one CSI-reportConfig reporting settings, CSI-ResourceConfig resource settings, and one or two lists of trigger states, indicating the resource set IDs for channel and optionally for interference measurement. Each trigger state contains an associated CSI-ReportConfig.

The NR supports three types of spatial-resolution CSI: standard-resolution (Type I), high-resolution (Type II) and enhanced Type II (eType II). The low-resolution CSI is targeted for SU-MIMO transmission since it relies on the UE receiver to suppress the inter-layer interference. This is possible since the number of received layers is less than the number of receiver antennas for a given UE. For MU-MIMO transmission, the number of received layers is typically larger than the number of receive antennas for the UE. The base station exploits beamforming/precoding to suppress inter-UE interference. Thus, a higher resolution CSI, capturing more propagation paths of the channel, is needed to provide sufficient degrees of freedom at the transmitter.

The UE 704 measures the spatial channel between itself and the serving base station using the CSI-RS transmitted from the base station 702 transmit antenna ports in order to generate a CSI report. The UE 704 then calculates the CSI-related metrics and reports the CSI to the base station 702. Using the reported CSIs from all UEs, the base station 702 performs link adaptation and scheduling. The goal of CSI measurement and reporting is to obtain an approximation of the CSI. This can be achieved when the reported PMI accurately represents the dominant channel eigenvector(s), thereby enabling accurate beamforming.

The Type II and the eType II CSI provide channel information with significantly higher spatial granularity. The reporting of a set of beams on a wideband basis together with the reporting of a set of combining coefficients on a more narrowband basis. The reported beams are linearly combined by means of the combining coefficients to provide a set of precoder vectors, one for each layer.

For Type II CSI, the combining coefficients are reported separately for each subband, despite the fact that the channels of neighbor subbands often have a significant mutual correlation. It is this reporting of a relatively large number of combining coefficients on a per-subband basis that leads to the relatively large reporting overhead for Type II CSI. The overall precoder W which the UE needs to report to the base station can be expressed as the product of two matrices W=W₁W₂, where W₁ is a wideband precoder and W₂ is a subband precoder.

The matrix W₁ is assumed to capture long-term frequency-independent characteristics of the channel. A single W₁ is therefore selected and reported for the entire reporting bandwidth (wideband reporting).

In contrast, the matrix W₂ is assumed to capture more short-term and potentially frequency-dependent characteristics of the channel. W₂ is therefore selected and reported on a subband basis, where a subband covers a fraction of the overall reporting bandwidth. Further, extended Type II (eType II) CSI allows improvement in the frequency-domain (FD) granularity of the PMI reporting.

The W₁ matrix selects a subset of the spatial beams 740 that serves as basis beams 742 for linear combination performed by W₂. This subset selection may be common across two polarizations and maybe for two transmission layers. The linear combination is performed per subband as well as independently across polarizations and layers to obtain combined beams 744.

In certain configurations, to reduce the feedback overhead for W₂, some partial information pertaining to linear combination such as the strongest of the 2 L linear combination coefficients and 2 L−1 wideband reference amplitudes for subband differential encoding of the linear combination coefficients in W₂ is also included in W₁. Therefore, the amplitude component of the linear combination coefficients may include wideband and subband components. The phase component may be per subband and configurable as QPSK or 8-PSK.

In more details, in this example, the base station 702 has a N₁·N₂ crosspolarized antenna elements. N₁ is the number of rows of antenna elements. N₂ is the number of antenna elements in each row. For a given layer k, the reported precoder vectors for all FD units can, for the eType II CSI, be expressed as

$${W}_{k} = [ {w}_{k}^{( 0 )} … {w}_{k}^{( {N}_{3} - 1 )} ] = {W}_{1} \times {\tilde{W}}_{2 , k} \times {W}_{f , k}^{H}$$

where N₃ is the number of FD units to be reported. W₁ is same for all FD units (wideband reporting) and also same for all layers.

Note that the matrix

$${W}_{k} = [ {w}_{k}^{( 0 )} … {w}_{k}^{( {N}_{3} - 1 )} ]$$

is not a precoder matrix mapping layers to antenna ports but just describes the set of precoder vectors for the full set of FD units (one precoder vector for each FD unit) for a given layer k. The compression matrix as well as the frequency domain (FD) basis

$${W}_{f , k}^{H}$$

of size M×N₃ consists of a set of row vectors from a discrete Fourier transform (DFT) basis and provides a transformation from the frequency domain of dimension N₃, corresponding to the N₃ FD units covered by the CSI reporting, into a smaller delay domain of dimension M. The linear combination coefficients matrix \tilde{W}_{2,k} of size 2 L×M maps from the smaller delay domain to the beam domain.

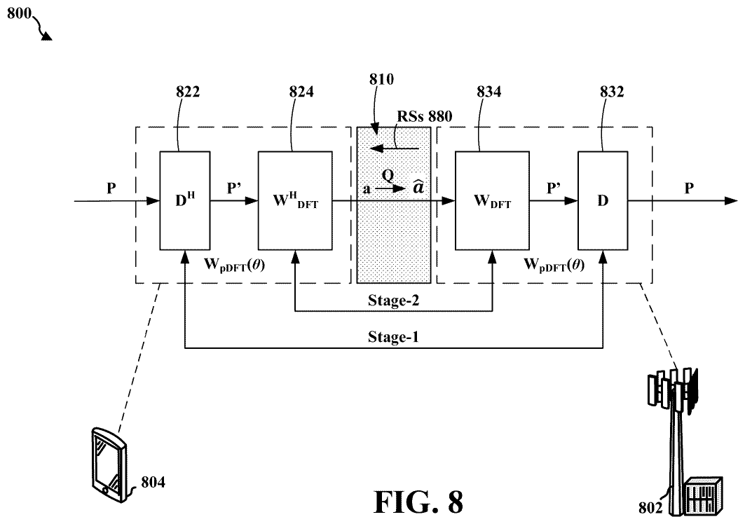

FIG. 8 is a diagram 800 illustrating a technique of CSI compression based on a two-stage linear combination. The UE 804 measures reference signals 880 transmitted by the base station 802 through a channel 810. Based on the measurements, the UE 804 can determine original precoder matrix P, which needs to be feedback to the base station 802.

As described supra, P can be represented as:

P=W₁W₂W_{f}^{H}
P contains N₃ precoder vectors corresponding to the N₃ subbands. W₁ contains 2 L vectors corresponding to 2 L DFT basis beams. L is the number of basis beams per polarization. In total, 2 L spatial beams are selected for two polarizations. W_{f}^{H} maps the N₃ subbands to M delay domains. As such, the above equation can be written as:

$$[ \begin{matrix}{p}^{( 0 )} & {p}^{( 1 )} & … & {p}^{( {N}_{3} - 1 )}\end{matrix} ] = [ \begin{matrix}{b}_{SD , 1} & {b}_{SD , 2} & … & {b}_{SD , 2 L - 1}\end{matrix} ] {W}_{2} [ \begin{matrix}{b}_{FD , 1}^{H} \\ {b}_{FD , 2}^{H} \\ ⋮ \\ {b}_{FD , M - 1}^{H}\end{matrix} ]$$

p⁽ⁱ⁾ represents precoder vector corresponding to the i^{th} subband, i=0, 1, . . . , N₃−1. p⁽ⁱ⁾ has 2N₁N₂ elements, b_{SD,j} represents the j^{th} DFT basis beam, j=0, 1, . . . , 2 L−1. b_{SD,j} has 2N₁N₂ elements. b_{FD,k} corresponds to the k^{th} delay domain dimension, i=0, 1, . . . , M−1. b_{FD,k} has N₃ elements. Accordingly, W₂ is a 2 L×M matrix. Further, P can be written as:

$$P = {\sum }_{j , k} {a}_{j , k} {b}_{S D , j} {b}_{F D , k} .$$

Further, the collection of a_{j,k} are the coefficients of W₂ and are denoted as a.

To further reduce the reporting overhead for CSI, the UE 804 may employ a two-stage report scheme. In the first stage, the UE 804 reports W₁ and W_{f}^{H}. In the second stage, the UE 804 determines W₂ and the coefficients a, and then reports the coefficients a.

In addition, in this technique, in the first stage, a pre-processing component 822 of the UE 804 applies a phase rotation matrix D^{H} to the original precoder matrix P to generate a rotated precoder matrix P′.

Subsequently, in the second stage, the rotated precoder matrix P′ is input into a PMI generation component 824. The PMI generation component 824 determines coefficients a according to a DFT basis matrix

$${W}_{D F T}^{H}$$

derived from W₁ and W_{f}^{H}. More specifically,

$$a = {W}_{D F T}^{H} {P}^{′}$$

$$a = {W}_{D F T}^{H} {D}^{H} P$$

Further, the PMI generation component 824 may truncate small coefficients in a to generate â, which is represented by the below equation.

â=Q(a)

Subsequently, the UE 804 reports â to the base station 802.

Upon receiving the coefficients â reported by the UE 804, the base station 802 uses a PMI determination component 834 to determine an approximate rotated precoder matrix \tilde{P}′ as follows:

\tilde{P}′=W_{DFT}â

Then a post-processing component 832 applies D to the approximate rotated precoder matrix \tilde{P}′ to obtain an approximate original precoder matrix \tilde{P}.

$$\tilde{P} = \tilde{D} {\tilde{P}}^{′}$$

$$\tilde{P} = \tilde{D} {W}_{D F T} \hat{a}$$

$$= \tilde{D} {W}_{D F T} Q ( {W}_{D F T}^{H} {D}^{H} P )$$

In certain configurations, the phase rotation matrix D can be chosen as the follows:

$$D = diag ( {e}^{j {θ}_{0}} , {e}^{j {θ}_{1}} , … , {e}^{j {θ}_{2 {N}_{1} {N}_{2} - 1}} ) = [ \begin{matrix}{e}^{j {θ}_{0}} & 0 & 0 \\ 0 & ⋱ & 0 \\ 0 & 0 & {e}^{j {θ}_{2 {N}_{1} {N}_{2} - 1}}\end{matrix} ] .$$

In the first stage under this technique, the base station 802 acquires long-term statistics of the channel 810 based on CSI reporting or uplink sounding from the UE 804. The statistics, for example, can be channel covariance matrix Q of the channel 810. Accordingly, the base station 802 can determine a phased rotation vector θ=[θ₀, . . . , θ_{2N}_{₁}_{N}_{₂}₋₁] based on channel features to concentrate energy distributed in the transformed domains. The phased rotation vector θ can be determined in several ways. For example, θ can be equal to argmax_{θ} d^{H}Qd to maximize beamforming gain, where d=[e^{jθ}^{₀}, e^{jθ}^{₁}, . . . , e^{jθN}^{₁}^{N}^{₂}⁻¹]^{T}. θ can also be found by eigen decomposition Q=VΛV^{H} and θ=angle(v₁) where v₁ represents most significant eigenvector of Q.

In particular, DW_{DFT} can be considered as alternative basis matrix W_{pDFT}(θ). Therefore,

\tilde{P}=W_{pDFT}(θ)â

θ can be determined either by base station or by UE. In either case, θ is signaled to the other side, and both sides update linear combination codebook basis W_{pDFT}(θ). In this example, W_{pDFT}(θ) is phase-rotated version of the DFT basis and is an orthonormal basis. Linear combination coefficients can be found by vector projection on W_{pDFT}(θ). Further, W_{pDFT}(θ) can be specialized to legacy DFT and oversampled DFT basis. Properly choose diagonal phase in D as well as the phased rotation vector θ can concentrate energy distributed in transformed domain to obtain â, so that â can be effectively represented by few non-zero coefficients.

When \tilde{D}=D^{-H}, the original precoder matrix P can be fully recovered in case of no quantization (i.e., Q=I). For the case D=I, it will be degraded to the legacy DFT basis.

The UE 804 and the base station 802 need to communicate information regarding D. Additional overhead may be incurred. As the UE's channel statistic is a relatively long-term measurement, it may not need to be update very frequently. CSI-RS resource(s) is transmitted by the base station, the UE measures the channel, determine CSI, and represent CSI using basis W_{pDFT}(θ). The UE feedbacks linear combination coefficients of that customized basis. In the examples described supra, the precoder matrix P is used as an example for CSI matrices that can be reported by the UE to the base station according to the disclosed techniques. Other CSI matrices can also be reported according to these techniques. Such CSI matrices may be H (channel coefficients), H^{H}H, or transmit side precoder. CSI-RS resource(s) can be non-precoded and can be reused for multiple sUEs since UE-specific statistics is characterized by codebook basis that is determined in stage-1. CSI-RS resource(s) in stage-2 can also considered being pre-coded for a group of UEs who share similar second order channel statistics. The precoded CSI-RS can efficiently reduce number of resources for UE to measure.

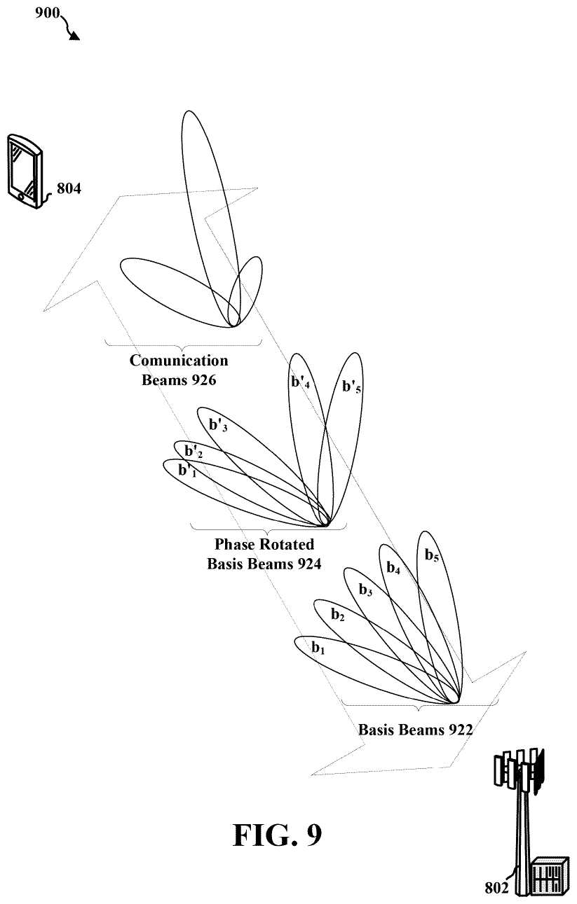

FIG. 9 is a diagram 900 illustrating an example of phase rotated DFT basis. In this simplified example, a base station 802 forms DFT basis beams 912 containing 5 beams b₁, b₂, b₃, b₄, and b₅. The UE 804 determines that best communication beams 926 for communicating with the base station 802 can be represented as a linear combination of the DFT basis beams 912 as W=a₁b₁+a₂b₂+a₃b₃+a₄b₄.

As described supra, the UE 804 utilizes the pre-processing component 822 to rotate the DFT basis beams 922 to obtain phase rotated beams 924. The communication beams 926 may be expressed as

$$W = {a}_{2}^{′} {b}_{2}^{′} + {a}_{3}^{′} {b}_{3}^{′}$$

using the phase rotated beams 924. Accordingly, the UE 804 now only reports coefficients

$${a}_{2}^{′} and {a}_{3}^{′} .$$

The linear combination representation of the best beam (or spatial filter) can be sparser with fewer significant coefficients, therefore, result in better compression.

Oversample DFT basis is one realization of phase rotated DFT basis, but its performance is tied to linear array architecture assumption. Cophasing (across non-collocated antenna panels/clusters) is another realization of phase rotated DFT basis. In fact, phase rotated DFT basis can be viewed as cophasing applied for every antenna.

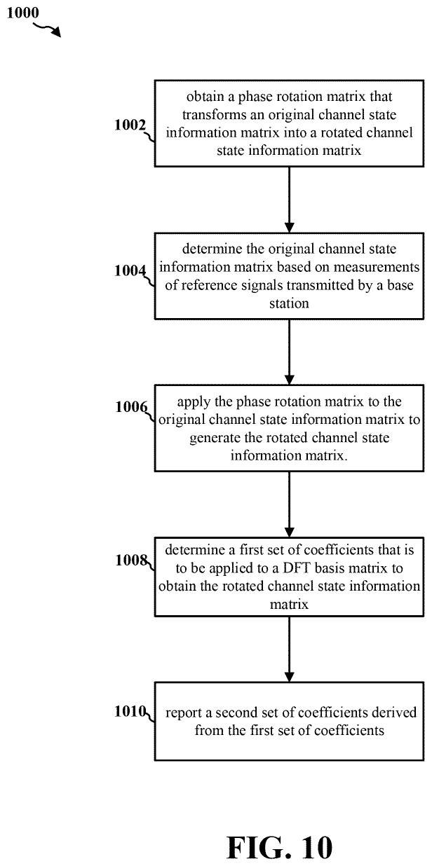

FIG. 10 is a flow chart 1000 of a method (process) for channel state information matrix reporting. The method may be performed by a UE (e.g., 804). In operation 1002, the UE obtains a phase rotation matrix that transforms an original channel state information matrix into a rotated channel state information matrix. In operation 1004, the UE determines the original channel state information matrix based on measurements of reference signals transmitted by a base station. In operation 1006, the UE applies the phase rotation matrix to the original channel state information matrix to generate the rotated channel state information matrix.

In operation 1008, the UE determines a first set of coefficients that is to be applied to a Discrete Fourier Transform (DFT) basis matrix to obtain the rotated channel state information matrix. In operation 1010, the UE reports, to the base station, a second set of coefficients derived from the first set of coefficients.

In certain configurations, the channel state information matrix is one of a precoder matrix or a channel matrix. In certain configurations, the UE receives the phase rotation matrix from the base station. In certain configurations, the UE determines the phase rotation matrix to maximize beamforming gain or by eigen decomposition and reports the phase rotation matrix to the base station. The phase rotation matrix may be reported in a first stage of multi-stage reporting.

In certain configurations, the UE determines the DFT basis matrix based on a long-term channel statistic between the UE and the base station and reports the DFT basis matrix to the base station. The DFT basis matrix may be reported in a first stage of reporting, with the second set of coefficients reported in a second stage of reporting that is more frequent than the first stage.

In certain configurations, the UE truncates small coefficients in the first set of coefficients to generate the second set of coefficients. In certain configurations, the second set of coefficients is the same as the first set of coefficients.

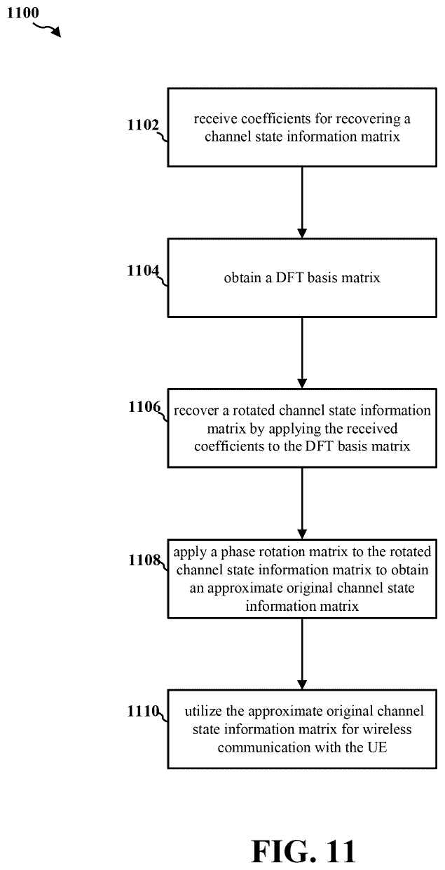

FIG. 11 is a flow chart 1100 of a method (process) for channel state information matrix recovery. The method may be performed by a base station (e.g., base station 702). In operation 1102, the base station receives, from a UE, coefficients for recovering a channel state information matrix. In operation 1104, the base station obtains a Discrete Fourier Transform (DFT) basis matrix. In operation 1106, the base station recovers a rotated channel state information matrix by applying the received coefficients to the DFT basis matrix.

In operation 1108, the base station applies a phase rotation matrix to the rotated channel state information matrix to obtain an approximate original channel state information matrix. In operation 1110, the base station utilizes the approximate original channel state information matrix for wireless communication with the UE.

In certain configurations, the base station transmits the phase rotation matrix to the UE. In certain configurations, the base station determines the phase rotation matrix to maximize beamforming gain and transmits the phase rotation matrix to the UE. In certain configurations, the base station determines the phase rotation matrix by eigen decomposition and transmits the phase rotation matrix to the UE. In certain configurations, the base station determines the DFT basis matrix based on a long-term channel statistic between the UE and the base station and transmits the DFT basis matrix to the UE. In certain configurations, the base station receives the DFT basis matrix from the UE.

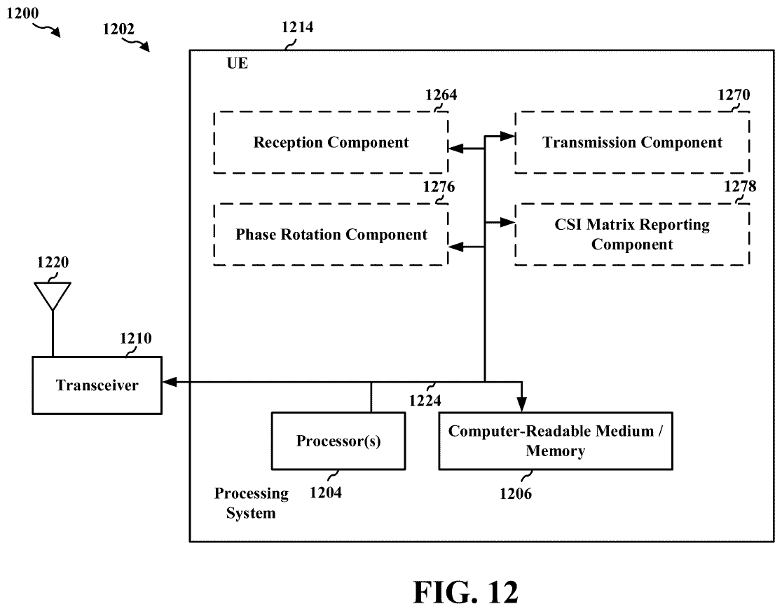

FIG. 12 is a diagram 1200 illustrating an example of a hardware implementation for an apparatus 1202 employing a processing system 1214. The apparatus 1202 may be a UE (e.g., the UE 704). The processing system 1214 may be implemented with a bus architecture, represented generally by a bus 1224. The bus 1224 may include any number of interconnecting buses and bridges depending on the specific application of the processing system 1214 and the overall design constraints. The bus 1224 links together various circuits including one or more processors and/or hardware components, represented by one or more processors 1204, a reception component 1264, a transmission component 1270, a phase rotation component 1276, a CSI matrix reporting component component 1278, and a computer-readable medium/memory 1206. The bus 1224 may also link various other circuits such as timing sources, peripherals, voltage regulators, and power management circuits, etc.

The processing system 1214 may be coupled to a transceiver 1210, which may be one or more of the transceivers 254. The transceiver 1210 is coupled to one or more antennas 1220, which may be the communication antennas 252.

The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1264. In addition, the transceiver 1210 receives information from the processing system 1214, specifically the transmission component 1270, and based on the received information, generates a signal to be applied to the one or more antennas 1220.

The processing system 1214 includes one or more processors 1204 coupled to a computer-readable medium/memory 1206. The one or more processors 1204 are responsible for general processing, including the execution of software stored on the computer-readable medium/memory 1206. The software, when executed by the one or more processors 1204, causes the processing system 1214 to perform the various functions described supra for any particular apparatus. The computer-readable medium/memory 1206 may also be used for storing data that is manipulated by the one or more processors 1204 when executing software. The processing system 1214 further includes at least one of the reception component 1264, the transmission component 1270, the phase rotation component 1276, and the CSI matrix reporting component component 1278. The components may be software components running in the one or more processors 1204, resident/stored in the computer readable medium/memory 1206, one or more hardware components coupled to the one or more processors 1204, or some combination thereof. The processing system 1214 may be a component of the UE 250 and may include the memory 260 and/or at least one of the TX processor 268, the RX processor 256, and the communication processor 259.

In one configuration, the apparatus 1202 for wireless communication includes means for performing each operation/procedure of the UE 704 referring to FIG. 10. The aforementioned means may be one or more of the aforementioned components of the apparatus 1202 and/or the processing system 1214 of the apparatus 1202 configured to perform the functions recited by the aforementioned means.

As described supra, the processing system 1214 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

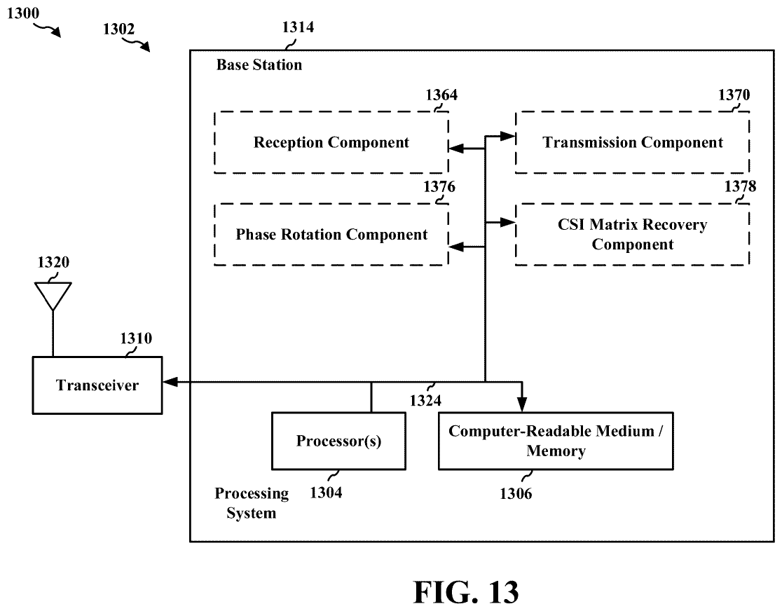

FIG. 13 is a diagram 1300 illustrating an example of a hardware implementation for an apparatus 1302 employing a processing system 1314. The apparatus 1302 may be a base station (e.g., the base station 802). The processing system 1314 may be implemented with a bus architecture, represented generally by a bus 1324. The bus 1324 may include any number of interconnecting buses and bridges depending on the specific application of the processing system 1314 and the overall design constraints. The bus 1324 links together various circuits including one or more processors and/or hardware components, represented by one or more processors 1304, a reception component 1364, a transmission component 1370, a phase rotation component 1376, and a CSI matrix recovery component 1378, and a computer-readable medium/memory 1306. The bus 1324 may also link various other circuits such as timing sources, peripherals, voltage regulators, and power management circuits, etc.

The processing system 1314 may be coupled to a transceiver 1310, which may be one or more of the transceivers 254. The transceiver 1310 is coupled to one or more antennas 1320, which may be the communication antennas 220.

The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1364. In addition, the transceiver 1310 receives information from the processing system 1314, specifically the transmission component 1370, and based on the received information, generates a signal to be applied to the one or more antennas 1320.

The processing system 1314 includes one or more processors 1304 coupled to a computer-readable medium/memory 1306. The one or more processors 1304 are responsible for general processing, including the execution of software stored on the computer-readable medium/memory 1306. The software, when executed by the one or more processors 1304, causes the processing system 1314 to perform the various functions described supra for any particular apparatus. The computer-readable medium/memory 1306 may also be used for storing data that is manipulated by the one or more processors 1304 when executing software. The processing system 1314 further includes at least one of the reception component 1364, the transmission component 1370, the phase rotation component 1376, and the CSI matrix recovery component 1378. The components may be software components running in the one or more processors 1304, resident/stored in the computer readable medium/memory 1306, one or more hardware components coupled to the one or more processors 1304, or some combination thereof. The processing system 1314 may be a component of the base station 210 and may include the memory 276 and/or at least one of the TX processor 216, the RX processor 270, and the controller/processor 275.

In one configuration, the apparatus 1302 for wireless communication includes means for performing each of the operations of FIG. 11. The aforementioned means may be one or more of the aforementioned components of the apparatus 1302 and/or the processing system 1314 of the apparatus 1302 configured to perform the functions recited by the aforementioned means.

As described supra, the processing system 1314 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
obtaining a phase rotation matrix that transforms an original channel state information matrix into a rotated channel state information matrix;
determining the original channel state information matrix based on measurements of reference signals transmitted by a base station;
applying the phase rotation matrix to the original channel state information matrix to generate the rotated channel state information matrix;
determining a first set of coefficients that is to be applied to a Discrete Fourier Transform (DFT) basis matrix to obtain the rotated channel state information matrix; and
reporting, to the base station, a second set of coefficients derived from the first set of coefficients.

2. The method of claim 1, wherein the channel state information matrix is one of a precoder matrix or a channel matrix.

3. The method of claim 1, further comprising:
receiving the phase rotation matrix from the base station.

4. The method of claim 1, further comprising:
determining the phase rotation matrix to maximize beamforming gain or by eigen decomposition; and
reporting the phase rotation matrix to the base station.

5. The method of claim 4, further comprising:
wherein the phase rotation matrix is reported to the base station in a first stage of multi-stage reporting.

6. The method of claim 1, further comprising:
determining the DFT basis matrix based on a long-term channel statistic between the UE and the base station; and
reporting the DFT basis matrix to the base station.

7. The method of claim 1, wherein the DFT basis matrix is reported to the base station in a first stage of reporting, wherein the second set of coefficients are reported to the base station in a second stage of reporting, wherein the second stage of reporting is more frequent than the first stage of reporting.

8. The method of claim 1, further comprising:
truncating small coefficients in the first set of coefficients to generate the second set of coefficients.

9. The method of claim 1, wherein the second set of coefficients is the same as the first set of coefficients.

10. A method of wireless communication of a base station, comprising:
receiving, from a user equipment (UE), coefficients for recovering a channel state information matrix;
obtaining a Discrete Fourier Transform (DFT) basis matrix;
recovering a rotated channel state information matrix by applying the received coefficients to the DFT basis matrix;
applying a phase rotation matrix to the rotated channel state information matrix to obtain an approximate original channel state information matrix; and
utilizing the approximate original channel state information matrix for wireless communication with the UE.

11. The method of claim 10, further comprising:
transmitting the phase rotation matrix to the UE.

12. The method of claim 10, further comprising:
determining the phase rotation matrix to maximize beamforming gain; and
transmitting the phase rotation matrix to the UE.

13. The method of claim 10, further comprising:
determining the phase rotation matrix by eigen decomposition; and
transmitting the phase rotation matrix to the UE.

14. The method of claim 10, further comprising:
determining the DFT basis matrix based on a long-term channel statistic between the UE and the base station; and
transmitting the DFT basis matrix to the UE.

15. The method of claim 10, further comprising:
receiving the DFT basis matrix from the UE.

16. An apparatus for wireless communication, the apparatus being a user equipment (UE), comprising:
a memory; and
at least one processor coupled to the memory and configured to:
obtain a phase rotation matrix that transforms an original channel state information matrix into a rotated channel state information matrix;
determine the original channel state information matrix based on measurements of reference signals transmitted by a base station;
apply the phase rotation matrix to the original channel state information matrix to generate the rotated channel state information matrix;
determine a first set of coefficients that is to be applied to a Discrete Fourier Transform (DFT) basis matrix to obtain the rotated channel state information matrix; and
report, to the base station, a second set of coefficients derived from the first set of coefficients.

17. The apparatus of claim 16, wherein the channel state information matrix is one of a precoder matrix or a channel matrix.

18. The apparatus of claim 16, wherein the at least one processor is further configured to receive the phase rotation matrix from the base station.

19. The apparatus of claim 16, wherein the at least one processor is further configured to:
determine the phase rotation matrix to maximize beamforming gain or by eigen decomposition; and
report the phase rotation matrix to the base station.

20. The apparatus of claim 19, wherein the phase rotation matrix is reported to the base station in a first stage of multi-stage reporting.
